(19) United States
(12) Patent Application Publication
(10) Pub. No.: US 2007/0046626 A1
(43) Pub. Date: Mar. 1, 2007

(54) Digital presenter

(75) Inventor: Wen-Chin Cheng, Jhubei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Lumens Digital Optics Inc., Jhubei City (TW)

(21) Appl. No.: 11/320,107

(22) Filed: Dec. 28, 2005

(30) Foreign Application Priority Data
Aug. 29, 2005 (TW) 094214875

(51) Int. Cl. G09G 5/00

(52) U.S. Cl. 345/156

(57) ABSTRACT

A digital presenter has a base, an image acquiring device with an automatic focusing function, and a flexible support device connected between the base and the image acquiring device.

### FIELD OF THE INVENTION

The present invention relates to a digital presenter, and more particularly to a digital presenter having a camera capable of automatic focusing and a flexible support arm.

### BACKGROUND OF THE INVENTION

Digital presenter is an image acquiring device composed of a camera and at least a support frame. The digital presenter is used to display what the camera has taken by using an external image output device such as a multi-media projector, a rear projector television, a general television and a liquid crystal display (LCD) monitor. In addition to image of a physical object, the digital presenter may also display a movable image through the image output device. For example, the digital presenter may be employed to display the physical object, such as a picture, an article, a book and the like. In displaying the physical object, the advantage is that details of the physical object can be effectively presented. As another example, the digital presenter may be used to conduct a video conference. In the video conference, the digital presenter is used to display information, data, pictures or even an object grabbed at hand which is associated with the conference. As yet another example, the digital presenter may be served as a device for a multi-media teaching program. Since the digital presenter is provided with RGB and video output signals that it may be used with a multimedia projector, a television, a computer monitor or other output devices.

Basically, the digital presenter is generally composed of a camera and at least a support device. The camera is typically a video camera with charge-coupled device (CCD) or CMOS device. The camera may be manually adjusted for its focusing distance. The support device is generally a support arm having a mechanical joint so that the support device may be extendable and contractible or foldable. In this case, the support arm is limited on its reachable position and angle due to the mechanical joint.

In addition, a small liquid crystal display (LCD) may also be provided on some digital presenters so that the user may check if the to-be-displayed object has been properly photographed. As such, when the digital presenter is used to display something, no external monitor is required and the user is not required to look at the external output device in adjusting position of the to-be-displayed object. In addition, a light source may also be disposed so as to provide a better visual effect with respect to the object on the display. For the light source arrangement, two-side light provision, single-side light provision and base light provision schemes are generally adopted and should be determined based upon object position and type (e.g. a paper, a transparent film and a negative film) so that an optimal visual effect may be obtained.

Since the user has to manually adjust the focusing distance of the lens of the conventional digital presenter, convenience of the use is limited. To enhance the convenience issue, digital presenters with automatic focusing function have been provided.

Since the support device of the conventional digital presenter is an extendable and contractible or foldable support arm having a mechanical joint, position and angle reachable by the support arm are greatly limited. As such, the digital presenter is not allowed to conduct a full-angle free photographing task. To solve this problem, support arms free from having the mechanical joint, being bendable or flexible at any angle within a strength range of the used material (Gooseneck support arm) have been utilized in the digital presenter without automatic focusing function, to achieve the full-angle free photographing function. Although the full-angle free photographing function may be achieved, the user still has to manually adjust the focusing distance of the lens and inconvenience of using the digital presenter still arises. There has been not any digital presenter having the camera equipped with the automatic focusing function and the flexible support arm concurrently so far. In this regard, convenience of use of the digital presenter still needs to be improved.

### SUMMARY OF THE INVENTION

It is, therefore, an object of the present invention to provide a digital presenter used for acquiring an image, which is capable of automatic focusing and having a flexible support arm so that the functions of operational convenience and full-angle of acquiring images can be obtained.

In accordance with the present invention, the digital presenter comprises a base, an image acquiring device having an automatic focusing function and a flexible support device connected between the base and image acquiring device. The support device is a support arm free from a mechanical joint and may be bendable at any angle within a specific strength range of material for the support arm. In an embodiment, the support device is composed of a plurality of flexible support arms.

Other objects, advantages and efficacies of the present invention will be described in detail below taken from the preferred embodiments with reference to the accompanying drawings.

### BRIEF DESCRIPTION OF THE DRAWINGS

The foregoing summary, as well as the following detailed description of the preferred embodiments, is better understood when read in conjunction with the appended drawings. It is understood, however, that the invention is not limited to the specific methods disclosed or illustrated. In the drawings:

FIG. 1 is a schematic view of a digital presenter according to a preferred embodiment of the present invention;

FIG. 2(a) is an exploded view of a flexible support arm composed of a plurality of flexible support arms of the digital presenter according to the present invention; and

FIG. 2(b) is a schematic view of the support arm shown in FIG. 2(a) after assembly according to the present invention.

### DETAILED DESCRIPTION OF THE PREFERRED EMBODIMENT

The present invention discloses a digital presenter, which will be appreciated after the description of the preferred embodiments below is read, sufficiently enabling persons skilled in the art to implement the digital presenter of the present invention. However, it should be noted that other embodiments may be possible and the preferred embodiments should not be deemed a limitation on the present invention.

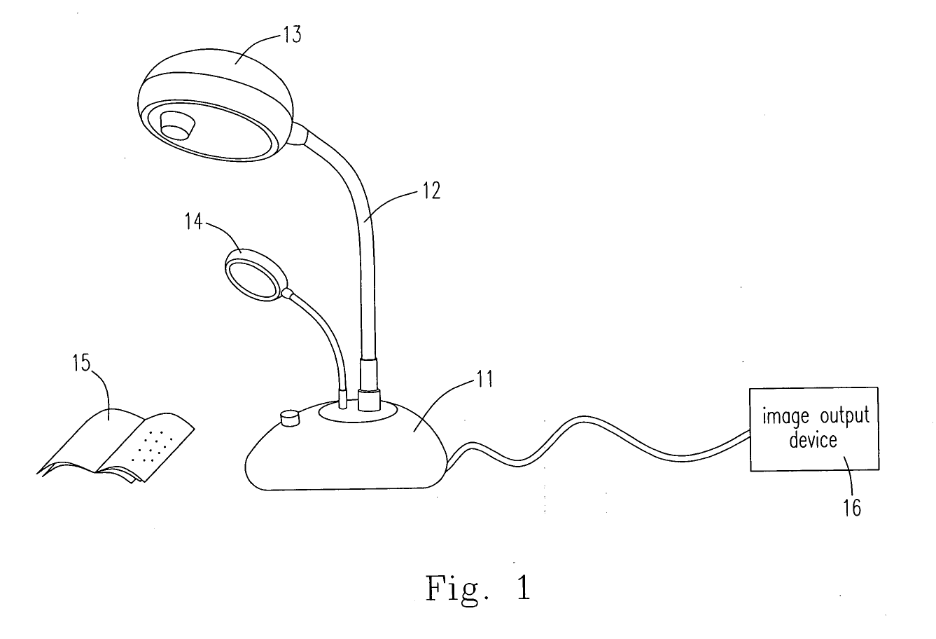

Referring to FIG. 1, the digital presenter according to the preferred embodiment of the present invention is schematically shown therein. The digital presenter comprises a base 11, a support arm 12, an image acquiring device 13, a to-be-display object 15, a lamp 14 and an image output device 16. In the embodiment, the support device 12 is a flexible support arm 12, the image acquiring device 13 is a charge-coupled device (CCD) 13, and the to-be-displayed object 15 is a book 15 and photographed by the image acquiring device 13. The lamp 14 is connected to the base 11 and used to facilitate an acquirement of the image of the book 15.

The flexible support arm 12 is located between the CCD 13 and the base 11 for connecting the CCD 13 and the base 11, which is in a strip shape and free from having any mechanical joint. The flexible support arm 12 is bendable or flexible at any angle within a strength range of a used material therefor and may be fixed at a specific position/orientation. The flexible support arm 12 is made of a material such as plastic or a metal. The CCD 13 has an automatic focusing function.

The digital presenter provides a full-angle free photographing function due to the flexible support arm 12 and the automatic focusing function due to the CCD 13, lending itself to be a competitive product and have a wider applicable range.

In using the digital presenter, the book 15 is first placed under the CCD 13, and the flexible support arm 12 and the CCD 13 are each adjusted to a proper position. Since the flexible support arm 12 may be curved at any angle within the strength range, the CCD 13 may be adjusted to a desired position and angle. As such, the digital presenter provides better convenience, compared with the conventional digital presenter.

Then, the CCD 13 may be hit slightly so as to be provided with a vibration, causing a variation of a horizontal angle of the CCD 13. In this manner, the automatic focusing function of the CCD 13 may be initialized and performed. As such, an optimal focusing distance between the CCD 13 and the book 15 may be automatically found.

Next, the CCD 13 acquires an image of the book 15 and then transmits the image to the image output device 16. The image output device 16 may be one of a television, a projector and a desktop computer monitor. Then, the image of the book 15 may be displayed on the image output device 16. When acquiring image, the lamp 14 may be turned on to take a clear image of the book 15 in prevention of poor image acquiring due to insufficient ambient light.

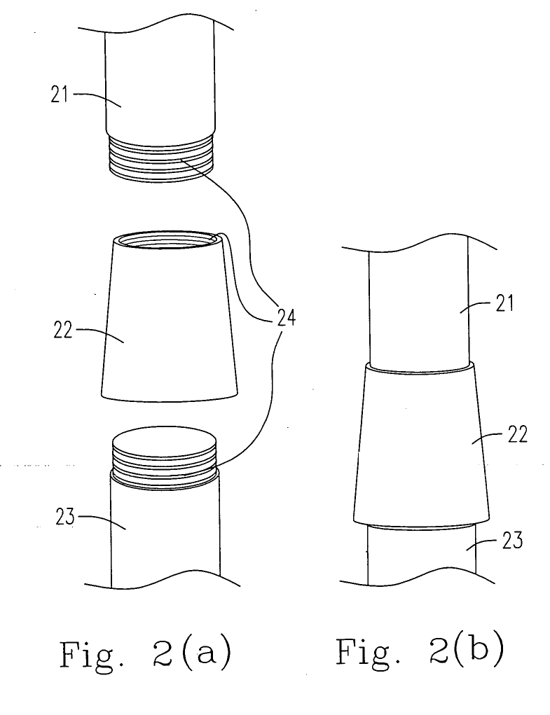

Referring next to FIG. 2(a), an exploded view of the flexible support arm having the plurality of flexible support arms of the digital presenter is schematically shown therein. The flexible support arm is composed of a plurality of flexible support arms and comprises a first flexible support arm 21, a cover ring 22, a second flexible support arm 23 and threads 24. By means of the cover ring 22, the first and second flexible support arms 21, 23 may be connected together, forming the flexible support arm of the digital presenter.

Referring to FIG. 2(b), the flexible support arm shown in FIG. 2(a) after assembly is schematically shown therein. Aside from the above connection form, other connection forms of the plurality of flexible support arms may be possible.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A digital presenter acquiring an image of an object that can transmit the image to an image output device, comprising:
a base;
an image acquiring device having an automatic focusing function; and
a flexible support device connected between the base and the image acquiring device.

2. The digital presenter according to claim 1, wherein the image acquiring device performs the automatic focusing function when being vibrated or a change of a relative angle of the image acquiring device with respect to the base.

3. The digital presenter according to claim 1, wherein the image output device is selected from a group consisting of a television, a projector, and a monitor.

4. The digital presenter according to claim 1, wherein the flexible support device is made of a metal.

5. The digital presenter according to claim 1, wherein the flexible support device is made of plastic.

6. The digital presenter according to claim 1, wherein the flexible support device is a gooseneck support device.

7. The digital presenter according to claim 1, wherein the flexible support device is in a strip shape, free from a mechanical joint, and is capable of being bendable at any angle.

8. The digital presenter according to claim 1, wherein the flexible support device is composed of a plurality of flexible supporting arms.

9. The digital presenter according to claim 1, wherein the image acquiring device is positioned at an angle with respect to the base and performs the automatic focusing function when the angle is changed.

10. The digital presenter according to claim 1, further comprising a lamp for facilitating an acquirement of the image of the object.

11. A digital presenter acquiring an image of an object that can transmit the image to an image output device, comprising:
a base;
an image acquiring device having an automatic focusing function;
a flexible support device connected between the base and the image acquiring device; and
a lamp facilitating an acquirement of the image of the object.

12. The digital presenter according to claim 11, wherein the image acquiring device performs the automatic focusing function when being vibrated or a change of a level of the image acquiring device with respect to the base.

13. The digital presenter according to claim 1, wherein the image output device is selected from a group consisting of a television, a projector, a display, a display screen, and a computer.

14. The digital presenter according to claim 11, wherein the flexible support device is made of a metal.

15. The digital presenter according to claim 11, wherein the flexible support device is made of plastic.

16. The digital presenter according to claim 11, wherein the flexible support device is a gooseneck support device.

17. The digital presenter according to claim 11, wherein the flexible support device is in a strip shape, free from a mechanical joint, and is capable of being bendable at any angle.

18. The digital presenter according to claim 11, wherein the flexible support device is composed of a plurality of flexible supporting arms.

19. The digital presenter according to claim 11, wherein the image acquiring device is positioned at an angle with respect to the base and performs the automatic focusing function when the angle is changed.
